(19) United States
(12) Patent Application Publication
(10) Pub. No.: US 2010/0332313 A1
(43) Pub. Date: Dec. 30, 2010

(54) USER SELECTABLE ADVERTISING NETWORKS

(75) Inventors: John M. Miller, Kirkland, WA (US); Janet Galore, Seattle, WA (US); Alexander Gounares, Kirkland, WA (US); Eric Horvitz, Kirkland, WA (US); Karim Farouki, Seattle, WA (US); Patrick Nguyen, Kirkland, WA (US); Brett Brewer, Sammamish, WA (US); Jayaram N.M. Nanduri, Sammamish, WA (US); Milind Mahajan, Redmond, WA (US); Oscar Murillo, Seattle, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/491,599

(22) Filed: Jun. 25, 2009

(51) Int. Cl. G06Q 30/00

(52) U.S. Cl. 705/14.44; 705/14.49; 705/14.55

(57) ABSTRACT

The claimed subject matter provides a system and/or a method that facilitates user selectable advertising networks. Advertising content can be formed into cohesive subsets of advertising. These subsets can be related to criteria to facilitate selection between available subsets of advertising content. A selection component can facilitate selection of the available subsets of advertising content based on these criteria. The criteria can be related to user preferences. Further the criteria can relate to explicit user preferences such as opt-in or opt-out indicia. The user can be presented with more relevant advertising content where user selection of advertising networks occurs.

### BACKGROUND

Advances in computer hardware and software are enabling computing systems to undergo a transformation in personalization of applications and systems to individual users' likes and dislikes. Further, advances towards massive data storage capacities, extreme computational power, super high speed networking and widely distributed computing environments all contribute to an almost unlimited amount of data available almost instantly on almost any computing device anywhere in the world. One example in this progression is the advent of high speed internet searches and data access on mobile computing devices such as smart phones.

Historically, computer systems have experienced a proliferation in features and functions that correlated roughly with advances in memory and computational power. Comparing early video games to modern video games provides a clear illustration of the improved user experience associated with increased memory and processing power. Of the many advanced features found in these exemplary computing systems, personalization of the application is not to be overlooked. In video games this personalization could include recording game settings for individual users across gaming sessions, personalized avatars, custom mapping of control devices, or other features that adapted the gaming experience to the user to improve that experience or provide some advanced feature that the user community found valuable.

Similar advances in personalization can be seen in other computer systems and products. Cookies, for example, have empowered internet services to adapt to individual computer systems or individual users. Even operating systems can be adapted to individual user preferences, for instance, by associating a user profile to a log in name. Modern mobile devices such as smart phones, PDA's, and the like, similarly can be personalized, such as by selecting how often a device synchronizes, aggressiveness of a power saving schema, availability of services or applications, and the like, on a user by user basis at a level that far surpasses early cell phones and electronic calendar devices.

Personalization of data and information is also becoming more and more prevalent as computing power and communication power increases. For example, many modern internet search engines allow personalization of search filters, for instance, to limit retrieval of mature material, limit searches to select databases, limit searches to certain languages, and the like, frequently on a user by user level of personalization. As another example, user customizable internet portals allow a user by user customization of an entry point to the internet by, for example, customizing news content displayed there, automatically logging into user selected email accounts, etc.

Where memory, connectivity and computational power continue to improve, user customization of nearly every aspect of interaction with the computing device or service is expected to become common place and every computer interaction will likely consider the user's “personality” in the interaction. For example, where a user is afraid of spiders, it would be expected that news stories, images, or advertisements related to spiders would be tailored so as to avoid exposing the user to an unpleasant experience. Similarly, where a user is a huge fan of a popular band, the computing device can be expected to rank news stories, or custom ring tones related to the band as more important to the user such that the information is more likely to be communicated to the user as the user interacts with the computing device.

Traditionally, advertising has been directed at consumers with very little adaptation to the user on an individual basis. Albeit that advertisements for products are frequently adapted to select groups, these adaptations are then generally pushed to target groups rather than to individuals. For example, advertisements for snacks and beverages can have very different advertisements pushed to viewers of a football game than a NASCAR event or prime time news program. Despite the ads being tailored to the expected viewer (or listener, depending on the advertising medium), the advertisements are generally not adapted to individual customer's preferences. Modern computing systems, while capable, have not traditionally employed improved advertising systems that account for individual user personalities in a stream of advertising presented to individual users. This is especially true in computing systems, where the current apex of advertising customization is generally to present ads to users related to key words in user queries.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates generally to advertising systems and/or methods. More particularly the disclosed subject matter relates to systems and/or methods that facilitate user selectable advertising networks and to adapt advertisements to individual end-users. These user selectable advertising networks provide an improved user experience with regard to the relevancy of advertising content to the user. Further, these systems and methods improve the value of advertising to advertising content providers by inherently being adapted to not only the target audience, but to the preferences of specific targeted customers in a target audience. This improved value can be leveraged to provide additional benefit to customers that select a particular advertising network or stream of advertising, for example, subscribers to a particular advertising channel can be given additional pricing incentives as compared to other advertising outlets for the same product to a more general audience. This can in turn reinforce a customer's loyalty to a particular brand, product, or advertising stream.

Further, by narrowing advertising content to relevant advertising based on user indicia, modification of the individual advertisements themselves can be improved. Whereas the advertising is by definition already targeted to a customer by being captured in a particular stream, dynamic modification of the advertisement itself can be focused on secondary factors rather than primary factors as is explained further herein. Additionally, in an aspect, content can be made inaccessible in a stream where it is determined not to be acceptable content for the end-user. Generally, this can be viewed as filtering advertising and then tailoring the filtered advertising. This can provide significant advantage over user-tailored modifications of non-filtered advertising.

In accordance with one aspect of the claimed subject matter, an advertising channel or stream of advertising can comprise content that is adapted to individual user preferences at a primary level by inclusion in the stream of advertising. For example, wherein the stream of advertising satisfies a user profile associated with a select user. Each advertising segment in the overall adapted advertising stream, can, but need not be individually tailored where the overall content of the advertising stream is comprised of selected advertising segments, such that the overall stream itself is adapted to a particular user's preferences. Where primary filtering has occurred, tailoring of individual advertisements comprising the stream can be tailoring of secondary factors or by exclusion of undesired content that is otherwise included in the stream.

In accordance with another aspect of the claimed subject matter, the advertising channel can comprise content that is adapted to individual user preferences wherein the individual advertising segments themselves are further adapted to satisfy a user profile associated with a select user. Where individual advertising segments comprising the overall stream of advertising presented on the advertising channel are adapted to a specific user's preferences, the sequence of advertising segments can be, but need not be, further adapted for that particular user. Thus, adaptation of delivered advertising content relevant a user's preferences from one or more advertising channels or streams can be accomplished at one or more levels of granularity (e.g., adaptation of the stream and/or the segments comprising the stream.)

In accordance with another aspect of the innovation described herein, the advertising networks can be advertiser networks (e.g., particular brands or corporations generate one or more advertising networks generally related directly to said brands or corporations.) The advertising networks can additionally be content provider networks (e.g., content providers, such as an internet service provider (ISP) can select ads from disparate brands to generate one or more content provider advertising networks). Similarly, the advertising networks can be 3^{rd} party networks that are neither branded advertisers nor general content providers (e.g., 3^{rd} party advertising resellers that combine advertising from disparate brands and provide that advertising to general content providers seeking one or more advertising streams, for example, an industry consortium or a general marketing company.) Further, some combination of these or other types of advertising networks can provide adapted advertising content to consumers.

In accordance with still another aspect of the claimed subject matter, an advertising channel can be a cohesive subset of more general advertising content. Thus, for example, where generalized advertising content is created by a first entity, this general content can be selectively grouped into a cohesive subset of advertising content that can represent a stream or channel of advertising that is adapted to users' preferences. This can include grouping the first entity's generalized content with other entities' generalized and/or specialized advertising content. Further, this can include adapting the first entity's generalized content directly to specialized content as part of a cohesive subset of advertising content for the entity themselves. The content at the subset level can represent content specifically adapted for a select user, or can represent a cohesive subgroup of content that can be further adapted to accord with a select user's preferences.

In accordance with a further aspect, the disclosed subject matter can facilitate generating user feedback to advertisers or providers related to the advertising channel (e.g., third parties, general content providers, advertisers, co-advertisers, competitive advertisers . . . ). This feedback can be employed to refine the advertising by further adapting the stream of advertising content, directly adapting advertising content comprising the advertising content stream, or providing benefit tokens to users. Examples can include providing more baseball related products in an advertising content stream to a user indicating that they have developed an interest in baseball, adapting bicycle advertising as a user's child matures such as with training wheels to single speed to multi-speed bicycles as the child ages, or providing a coupon or other financial incentive to a loyal subscriber of a particular advertising content channel.

In an additional aspect of the disclosed subject matter, the subsets of advertising content (e.g., a plurality of advertising streams or channels) can be selectively accessed based at least in part on a user's preferences. As an exceedingly simplistic example, if advertising stream A is related to sports, West-coast teams, and proponents of environmentally friendly products, and stream B is related to sports, East-coast teams and persons ambivalent about environmentally friendly products, a user preference can selectively allow advertising stream A to be presented to a user's cell phone browser wherein that user likes sports, lives in Seattle and is environmentally conscious. Similarly, another user can selectively be presented with advertising stream B where they are from Boston, enjoy hockey and are only a little into environmentally friendly products. Where additional preferences and user selections can be considered, the subsets of advertising content can become increasingly adapted to particular users as will be appreciated by one of ordinary skill in the art.

Further, these selected streams can then facilitate additional refinement for the individual end-users, for example, several advertisements in stream A, such as a pizza ad and a Seattle Sounders team ad, can be tailored to include a grunge music background where the Seattle user is a fan of grunge music. Further for example, where the Seattle user is also female, the ads can be individually dynamically modified to include a male voice over of the voice content where statistically, this results in more response to the ad for this particular user. In an aspect, none of the exemplary dynamic modifications relate to the primary advertising content, e.g., the thing or service being sold. Rather, the exemplary modifications relate to secondary advertising factors that can influent the effectiveness of an ad for a particular user.

In another aspect, inferences about user preferences can be employed in selecting advertising content subgroups made available to individual users. This can be in addition to or in place of a determinative selection component that can employ techniques including, but not limited to, user populated profiles, user opt-in, user opt-out, agglomerative user profile formation, direct purchase of user profile information, or combinations thereof.

In an important further aspect, a privacy component can be employed at one or more levels of the disclosed subject matter to protect user information from being disseminated improperly. This serves to not only simply keep private information private, but further reinforces a user's confidence in the system such that they are willing to entrust such systems with more accurate and personal information than they would for an untrustworthy or unscrupulous system. This additional data can be employed to improve the performance of these types of systems. This sensitive type of data may not be available without implementation of privacy standards through a privacy component.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates providing access to selected advertising networks.

FIG. 2 illustrates a block diagram of another exemplary system that facilitates providing access to selected advertising networks.

FIG. 3 illustrates a block diagram of an exemplary system that facilitates providing access to selected advertising networks across a communications network.

FIG. 4 illustrates a block diagram of another exemplary system that facilitates providing access to selected advertising networks across a communications network.

FIG. 5 illustrates a block diagram of an exemplary system that facilitates providing access to selected advertising networks and employs a feedback aspect.

FIG. 6 illustrates a block diagram of an exemplary system that facilitates providing access to selected advertising networks, employing feedback and inferential aspects.

FIG. 7 illustrates an exemplary methodology that facilitates providing access to selected advertising networks.

FIG. 8 illustrates another exemplary methodology that facilitates providing access to selected advertising networks.

FIG. 9 illustrates exemplary methodology that facilitates providing access to selected advertising networks with a feedback aspect.

FIG. 10 illustrates another exemplary methodology that facilitates providing access to selected advertising networks with a feedback aspect.

FIG. 11 illustrates an exemplary networking environment, wherein the novel aspects of the claimed subject matter can be employed.

FIG. 12 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “manager,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

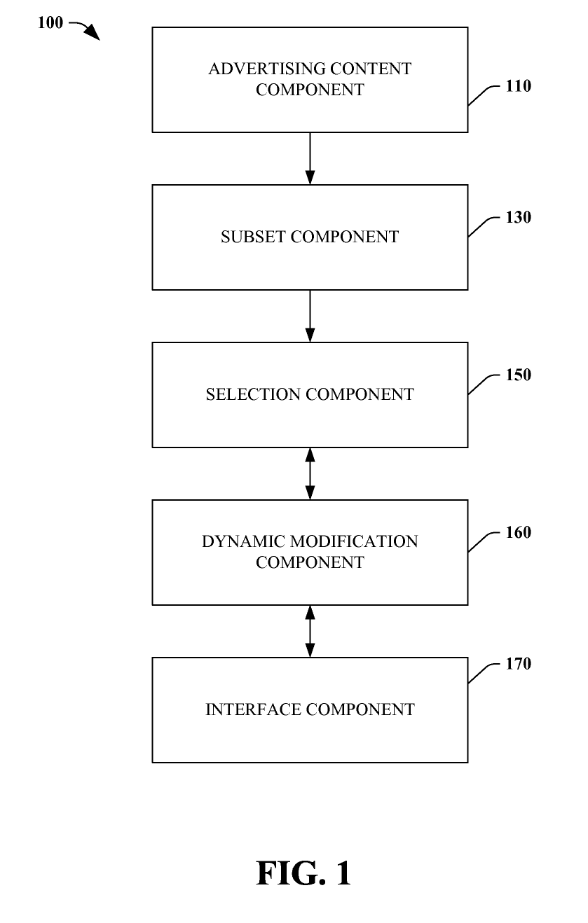

Now turning to the figures, FIG. 1 illustrates a system 100 that facilitates providing access to selected advertising networks. System 100 can include an advertising content component 110. Advertising content component 110 can provide advertising content to other components of system 100. In an aspect, advertising content component can be a repository of advertising content. This repository can be a single repository or a distributed repository. Further, the repository can include numerous forms of advertising stored in a format amenable to computer system access (e.g., electronic database, flash memory, optical disk, RAM, ROM, combinations thereof, or any other storage format that would facilitate access by a computer as will be appreciated by one of ordinary skill in the art.)

The advertising content component 110 can, in an aspect, source advertising content. As an example, advertising content component 110 can include a memory component (not illustrated) in a cell phone that stores a library of advertising content accessible by the cell phone. In another example, the advertising content component 110 can be located on an internet server and source advertising content to a user's cell phone through a mobile web browser. One of skill in the art will appreciate that numerous other configurations of an advertising content component can facilitate a nearly limitless number of sourcing configurations allowing user access to advertising content related to the advertising content component 110 and that all such permutations are within the scope of the disclosed subject matter.

Advertising content component 110 can further source advertising content that is stored outside of the advertising content component 110. For example, advertising content component can be a program module that facilitates other system 100 component access to advertising content store related to disparate storage memory. This storage memory can be, for example, an advertising content store on a manufacturer's server, an advertising content store on a local internet service provider (ISP) server, a memory store on a user device having an advertising content store, a third party advertising content store, combinations thereof, or any of numerous other advertising content stores as will be appreciated by one of skill in the art. For example, the advertising content component 110 can facilitate sourcing advertising content from a storage area on a famous tennis shoe maker's server to a user's digital radio or PDA.

System 100 can further include a subset component 130. Subset component 130 can be communicatively coupled to an advertising content component 110. Subset component 130 can facilitate forming subsets of advertising content. This content can be sourced by advertising content component 110. The sourced content can be general advertising content or can be more specific content (e.g., advertising content already refined according to some predetermined parameter(s), for example, just athletic shoe advertising, just beer commercials related to baseball games occurring within the next seven days, . . . ).

Subset component 130 can form at least a subset of the sourced advertising content. As will be apparent to one of skill in the art, a plurality of advertising content subsets can be formed where sufficient advertising content is sourced and where sufficient parameters are known to facilitate forming related subsets of the sourced advertising content. As an example, subset component 130 can form two subsets of sourced advertising content. These two subsets can be regarded as “channels” or “streams” of advertising content. Thus, in the example, the two advertising subsets could be channel A and channel B (or stream A and stream B).

As an example, advertising component 110 can source advertising content for subset component 130. This content can be related to sports advertising (e.g., the sourced advertising content is a form of specific content parameterized to sports.) Subset component can form, for instance, three subsets or streams of advertising content from the sourced content: football, baseball, and basketball streams. In another instance, subset component can form fifty subsets of advertising content such that the content in each channel is related to a particular state. In another instance, 150 channels can be formed such that each channel is related to a state and one of football, baseball, or basketball. This example is provided merely to facilitate ease of understanding and is not provided to limit the disclosure in any way.

Subset component 130 can further dynamically adjust the number and/or type of subsets to accommodate for changes in sourced advertising content, designated subset parameters, inferred subset parameters, or combinations thereof. For example, where a channel relates to fruit from Florida and an the sourced advertising content relates only to Chilean fruit because of the season, the channel can be reformed as just fruit or can become seasonal fruit, or otherwise re-parameterized to adapt to the sourced advertising content. Similarly, the fruit firm Florida channel can be empty and a new channel fruit from Chile can be populated. As another example, where subset parameter's are adjusted based on an inference that user interests are to fruit in general rather than Floridian fruit specifically, the channel can be dynamically adjusted to subset sourced advertising content into a fruit stream. One of skill in the art will appreciate that numerous dynamic reconfigurations of the number and types of advertising subsets can be enabled by the disclosure and that all such permutations are within the scope of the disclosed subject matter.

Subset component 130 can further form subsets based on numerous other parameters, for example data related to users' preferences. Where for example, numbers of users are interested in hybrid vehicles, subset component 130 can form a channel related to hybrid vehicles. This can facilitate automatic formation of advertising content subsets based at least in part on predetermined or inferred criteria. For example, a brand with a highly positive reputation amongst users can qualify for incorporation into an advertising content stream for “premium” brands.

The subset component 130 can further include sourced advertising content in a plurality of subsets, for example tomato advertising may appear in both a fruit channel and a vegetable channel to account for the common misconception that tomatoes are vegetables. Subset component 130 can further provide feedback to advertisers (not illustrated) to allow refinement of advertising content. For example, where a need for ski equipment advertising content adapted to Brazilian cultural preferences is indicated but little such advertising is sourced, feedback can be provided to encourage the production of such culturally directed advertising. Subset component 130 can be communicatively coupled to selection component 150.

Selection component 150 can receive advertising content and can selectively allow access to the received content. This selectivity can be, for example, based at least in part on criteria related to user preferences. Where subset component 130 can provide a plurality of advertising content subsets, selection component 150 can facilitate selectively allowing access among the advertising content subsets. Selected access can refer to selecting from among the different subsets, within any one subset, or combinations thereof.

Dynamic modification component 160 facilitates adapting aspects of the selected stream of content to a particular user. This can include selectively removing end-user access to content (e.g., not allowing a particular ad to be viewed or heard by an end user) where that content is determined to not be acceptable for a particular user despite otherwise being included in the selected stream, for example, otherwise meeting numerous user criteria but being an advertisement that has previously been specifically banned by the user. The dynamic modification can be to one or more of the advertisements comprising the selected ad stream. The dynamic modification component 160, in an aspect, can modify only secondary aspects of advertising. Secondary advertising aspects are those aspects not directly related to a product or service of the advertisement. For example, a primary aspect can be a particular car model while a secondary aspect can be the sound track to the car ad, the background image of the car ad, the ethnic appearance of a salesperson in the car ad, or even the color of the particular car in the car ad, among numerous other possible secondary aspects.

Wherein the advertising stream is already assumed to provide a reasonably narrow set of advertising to the user under the instant systems and methods, dynamic modification of the stream components can beneficially ignore modification of a primary aspect. This can significantly reduce the complexity of dynamic modifications to advertising content for effective advertising. For example, in a traditional system, the ad can be for a vehicle, and the dynamic tailoring can then try to insert a sedan rather than a pickup truck for a particular end-user. This can cause significant adaptations to the advertisement that can be computationally expensive. In contrast, the instant systems and methods can present only sedan commercials as part of the advertising stream, thus, dynamic modifications to the individual ads in the stream can focus on the secondary aspects of the advertisement, such as the colors of the text displayed, the ethnic appearance of a salesperson in the ad, etc., without also having to address the burden of the primary aspect modifications as in the conventional system or method.

System 100 can further comprise an interface component 170 to facilitate user access to the selected subset of advertising content associated with selection component 150 through dynamic modification component 160. For example, interface component can be a cell phone, a PDA, a laptop computer, a desktop computer, a digital radio or portable music device, a television, or any of a nearly limitless number of computer devices that can facilitate presenting advertising content to a user. Interface component 170 can be associated with criteria (not illustrated) related to a user's preferences.

In an example, a user can prefer not to see or hear sports related advertising, this preference can facilitate selectively limiting sports related advertising content at selection component 150. Where, for instance, advertising content component 110 sources advertising content with and without sports aspects, subset component 130 can, for instance, form a sports related advertising content channel and a non-sports related advertising content channel. Continuing the example, the selection component 150 can selectively limit the sports related channel and selectively allow the non-sports related channel to pass through to dynamic modification component 160. Dynamic modification component 160 can then selectively modify the secondary aspects of the advertising to narrowly tailor the advertising to the target end-user and allow access to the adapted stream through the interface component 170 by the end-user. In an alternative form of this example, where the subset component 130 provides a third channel having both sports related and non-sports related advertising content, the selection component 150 can selectively allow access to only the non-sports related content of the third channel. In a further extension of this example, the selection component 150 can further determine or infer that the user's preference for not being exposed to sports related advertising is a low threshold and that advertising with limited sports related themes are allowable (e.g., an ad for a football fantasy vacation can be restricted while an ad for a sale on steaks at the grocery in conjunction with the start of tailgating season can be allowed.)

Selection component 150 can further adapt selection dynamically. Thus, as selection criteria change the selection component can intelligently adapt to select appropriate advertising content. For example, where a user prefers books to movies, but now has little time to read for pleasure, the selection component 150 can react by dynamically allowing increased access to streams of advertising content related to movies. This can be in addition to similar intelligent adaptation of secondary advertising aspects by dynamic modification component 160. For example, where more movie ads are in the stream, the selection of which clips of any particular movie being advertised can be dynamically selected by the dynamic modification component 160 for each movie ad in the stream (e.g., the particular movie is a primary aspect, while selection of clips for that movie can be a secondary aspect, for instance, for a single movie titled “Speeding Over Europe”, selection of more tender scenes can be made for a romantically inclined moviegoer and more action scenes for a more macho target end-user without departing from the primary advertising aspect of advertising “Speeding Over Europe”.) One of skill in the art will appreciate that a limitless number of variations can be achieved and that all such examples are within the scope of the disclosed subject matter.

At a very high level, advertising content can be formed into cohesive channels in a dynamic and intelligent manner, from which selected advertising content can be accessed by a user in a dynamic and intelligent manner to provide the user with highly relevant advertising content. This description is not presented to limit the disclosed subject matter and is only intended to provide a general impression of the related aspects of the innovation. What is relevant to a user can be related to data mined from user actions, decisions, and schema. In an instance, user relevancy can be explicit, such as opting into or out of an advertising content channel. In another instance, user relevancy can be implicit, such as by accessing a particular website or data source. One of skill in the art will appreciate that volumes of data can be captured and associated to a user and that all such information can be employed in forming a user profile that can facilitate determining relevancy of advertising content to a user. All such profile techniques or methods of determining relevancy are within the scope of the disclosed subject matter as it relates to selectively accessing advertising content. Further, it will be appreciated that privacy concerns are likely to arise and that the disclosed subject matter considers these issues as is disclosed herein.

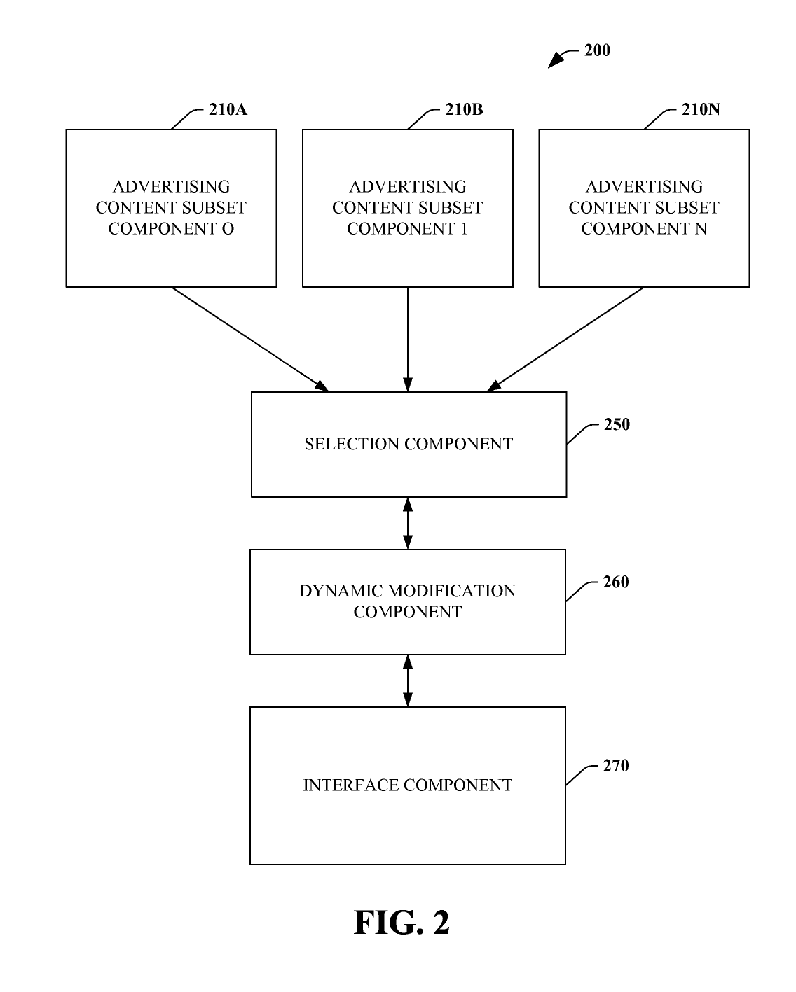

FIG. 2 illustrates a system 200 that facilitates providing access to selected advertising networks. System 200 can be the same as or similar to system 100. System 200 can include N advertising content subset component(s) 210A, 210B . . . 210C (e.g., advertising content subset component 0, advertising content subset component 1 . . . advertising content subset component N). Each advertising content subset component can provide at least a channel or stream of advertising content similar to that described for components 110 and 130 of system 100. For example, where advertising content subset component 0 (e.g., 210A) can generate one or more cohesive stream of advertising content. Similarly, each additional advertising content subset component can also source one or more cohesive stream of advertising content.

In an aspect, each advertising content subset component 210A, 210B . . . 210C can be a repository of advertising content and provide at least a subset of that content. These repositories can each be single repository or a distributed repository similar to aspects of advertising content component 110 in system 100. Each advertising content subset component 210A, 210B . . . 210C can, in an aspect, source at least a subset of available advertising content. As an example, advertising content subset component 0 (210A) can include a memory component (not illustrated) in a cell phone that stores a library of advertising content with a subset made accessible to the cell phone, while advertising content subset component 1 (210B) can be located on an internet server and source advertising content subsets related to a particular brand name to the user's cell phone through a mobile web browser, while advertising content subset component N (210C) can be a third party aggregator of advertising content providing a subgroup related to the brand preferences of the user to the user's cell phone. One of skill in the art will appreciate that numerous other configurations of an advertising content subgroup components 210A, 210B, . . . 210C can facilitate a nearly limitless number of advertising content subgroup sourcing configurations allowing user access to advertising content related to a plurality of advertising content sources and that all such permutations are within the scope of the disclosed subject matter.

Advertising content subset component 210A, 210B . . . 210C, can further source advertising content that is stored outside of the advertising content subset components 210A, 210B . . . 210C, similar to aspects of advertising content component 110 of system 100. For example, the advertising content subset component 0 (210A) can facilitate sourcing advertising content subsets from a storage area on a famous tennis shoe maker's server to a user's digital radio while advertising content subset component N (210C) can source advertising content subsets from a local memory store of advertising content. One of skill in the art will appreciate that each advertising content subset component 210A, 210B . . . 210C is not restricted to a single memory store for sourcing advertising content, that they may individually or collectively function as content aggregators, and that all such permutations for sourcing advertising content in cohesive subsets is considered within the scope of the disclosed subject matter.

In an aspect advertising content subset components 210A, 210B . . . 210C can facilitate forming subsets of advertising content from other cohesive and non-cohesive advertising content sources such that the subsets of advertising content form at least a cohesive subset of the available advertising content. As will be apparent to one of skill in the art, a plurality of advertising content subsets can be formed where sufficient advertising content is available and where sufficient parameters are known to facilitate forming cohesive subsets of the available advertising content. This can be similar to aspects of subset component 130 of system 100.

As an example, advertising content subset components 0 to N (210A, 210B . . . 210C) where N=2 can source advertising content subsets. This content can be related to sports advertising. In an instance, advertising content subset component 0 (210A) can form three subsets or streams of advertising content from advertising content as separate pro-football, pro-baseball, and pro-basketball streams; advertising content subset component 1 (210B) can similarly form three streams of advertising content as college-football, college-baseball, and college-basketball streams, and advertising content subset component 2 (210C) can form a subset of advertising content from sourced content for all high school football, baseball, and basketball as a single stream. In another instance, each of advertising content subset components 0 to 2 (210A, 210B . . . 210C) can form fifty subsets of advertising content per component such that the content in each channel is related to a particular State and all 50 channels from advertising content subset component 0 (210A) are related to football, all 50 channels on advertising content subset component 1 (210B) are related to baseball, and all 50 channels on advertising content subset component 2 (210C) are related to basketball (e.g., 50 channels by state for each sport class for a total of 150 channels from the three advertising content subset components 0 to N (210A, 210B . . . 210C) where N=2.) This example is provided merely to facilitate ease of understanding and is not provided to limit the disclosure in any way.

Further, similar to subset component 130 of system 100, advertising content subset components 0 to N (210A, 210B . . . 210C) can dynamically adjust the number and/or type of subsets formed to accommodate changes in sourced advertising content, designated subset parameters, inferred subset parameters, or combinations thereof. One of skill in the art will appreciate that the numerous dynamic reconfigurations of the number and types of advertising subsets are within the scope of the disclosed subject matter. Also similar to subset component 130 of system 100, advertising content subset components 0 to N (210A, 210B . . . 210C) can form subsets based on numerous other parameters, for example data related to users' preferences. This can facilitate automatic formation of advertising content subsets based at least in part on predetermined or inferred criteria. For example, a brand with a highly positive reputation amongst users can qualify for automatic incorporation into an advertising content subset related to “premium” brands.

Advertising content subset components 0 to N (210A, 210B . . . 210C) can further include sourced advertising content in a plurality of subsets, for example tomato advertising may appear in both a fruit channel and a vegetable channel to account for the common misconception that tomatoes are vegetables and further the fruit and vegetable channels can be from the same advertising content subset component or from disparate advertising content subset components 0 to N (210A, 210B . . . 210C). Advertising content subset components 0 to N (210A, 210B . . . 210C) can further provide feedback to advertisers (not illustrated) to allow refinement of advertising content.

Advertising content subset components 0 to N (210A, 210B . . . 210C) can be communicatively coupled to selection component 250. Selection component 250 can be the same as or similar to selection component 150 from system 100.

Selection component 250 can receive one or more advertising content subsets similar to selection component 150 is system 100 and can selectively allow access to the received content. This selectivity can be, for example, based at least in part on criteria related to user preferences. Where advertising content subset components 0 to N (210A, 210B . . . 210C) can provide a plurality of advertising content subsets, selection component 250 can facilitate selectively allowing access among the advertising content subsets. Selected access can refer to selecting from among the different subsets, within any one subset, or combinations thereof.

Selection component 250 can be communicatively coupled to dynamic modification component 260 which can be the same as, or similar to, dynamic modification component 160. Dynamic modification component 260 can facilitate the adaptation of content comprising the selected advertising streams to a single user. This can be by way of dynamic modification of secondary aspects of the advertising to narrowly tailor the advertising to targeted end-users. For example, where a premium furniture products stream passes through selection component 250, dynamic modification component 260 can effect a change in a particular ad for a bed by, for example, causing the background images in the ad to include images of the target end-user bedroom or rims similar thereto, for example in mood or lighting. Further, for example, modified secondary aspects could include, employing classical music that the target end-user owns and listens to often, brightening or darkening the brightness of the ad, or including a map to the store in the ad from the user's current location. One of skill in the art will appreciate that numerous secondary factors can be tweaked to adapt any particular ads in a stream to a particular user's tastes to increase the efficacy of the ad itself. This is effective because the computing resource scan be focused on the secondary aspects wherein the primary aspects can predominantly be ignored where channelization presumably is presenting a relevant set of primary products and services.

System 200 can further comprise an interface component 270 to facilitate user access to the selected subset of advertising content associated with selection component 250 and dynamic modification component 260. Interface component 270 can be the same as, or similar to, interface component 170 of system 100. For example, interface component 270 can be a cell phone, a PDA, a laptop computer, a desktop computer, a digital radio or portable music device, a television, or any of a nearly limitless number of computer devices that can facilitate presenting advertising content to a user. Interface component 270 can be associated with criteria (not illustrated) related to a user's preferences.

In an example, a user can prefer not to see or hear negative political advertising and this preference can facilitate selectively limiting political advertising content at selection component 250. Where, for instance, advertising content subset components 0 to N (210A, 210B . . . 210C) source advertising content with positive and negative political advertising aspects, the selection component 250 can selectively limit the negative political content channels and selectively allow the positive political advertising content channels to pass through dynamic modification component 260 to the interface component 270 for access by the user. Further, dynamic modification component 260 can tailor the secondary aspects of a positive political ad to tailor it for the specific recipient of the ad, for example, by selecting a candidate's position on a relevant political issue (e.g., the secondary aspect) to be presented for a particular candidate (e.g., the primary aspect). In an alternative form of this example, where advertising content subset components 0 to N (210A, 210B . . . 210C) provide a third channel having both positive and negative political advertising content, the selection component 250 or dynamic modification component 260 can selectively allow access to only the positive content of the third channel by actively restricting access to unwanted content. In a further extension of this example, the selection component 250 can further determine or infer that the user's preference for not being exposed to negative political advertising is a low threshold and that advertising with negative political themes are allowable where another aspect of the advertising is considered a higher threshold aspect (e.g., a negative political advertisement that relates to education can be restricted for a user without children while a negative political advertisement that relates to taxes can be allowed.)

Selection component 250 can further adapt selection dynamically. Thus, as selection criteria change the selection component can intelligently adapt to select appropriate advertising content. For example, where a user prefers books to movies, but now has little time to read for pleasure, the selection component 250 can react by dynamically allowing increased access to streams of advertising content related to movies. Similarly, dynamic modification component 260 can function in an intelligent manner. One of skill in the art will appreciate that a limitless number of variations can be achieved and that all such examples are within the scope of the disclosed subject matter.

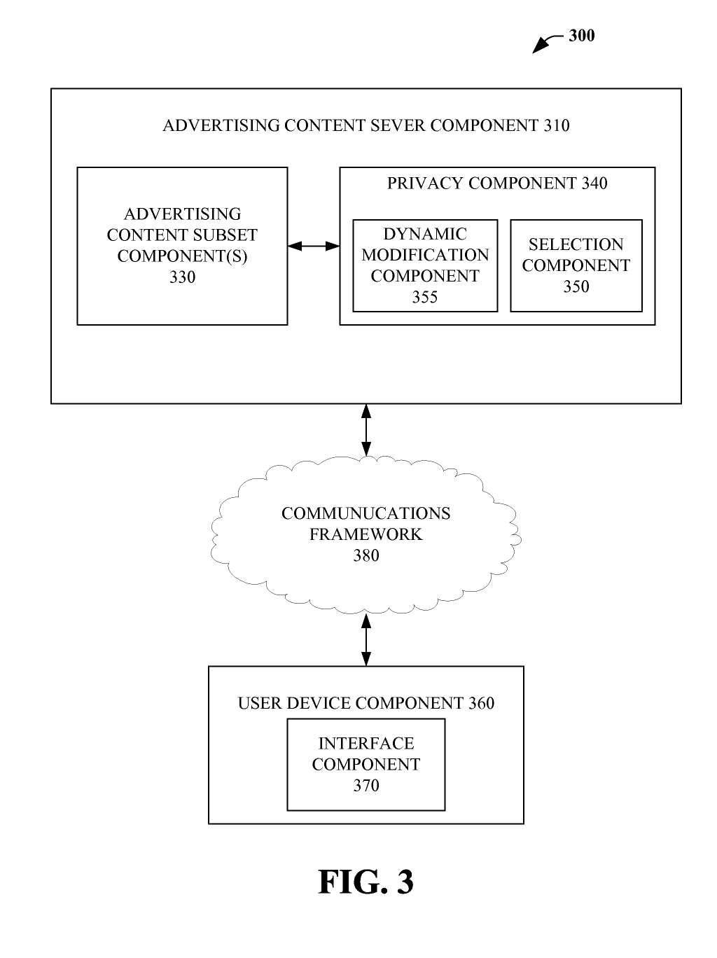

FIG. 3 illustrates a system 300 that facilitates providing access to selected advertising networks. System 300 can include an advertising content server component 310. The advertising content server component 310 can facilitate serving advertising content to remote systems. Advertising content server component 310 can include one or more advertising content subset components 330 that can be the same as or similar to advertising content subset components 0 to N (210A, 210B . . . 210C) from system 200.

Advertising content subset component(s) 330 can be communicatively coupled to privacy component 340 which in an embodiment can include selection component 350 and dynamic modification component 355. Selection component 350 can be the same as or similar to selection component 150 from system 100 and/or selection component 250 from system 200. Dynamic modification component 355 can be the same as or similar to dynamic modification component 160 from system 100 and/or dynamic modification component 260 from system 200. The inclusion of a privacy component 340 illustrates observance of the serious nature of safeguarding user selection and preference data. Where users feel that care is not taken with regard to personal data, they can often feel that a service or product is untrustworthy. This can result in user's deploying false or misleading data, providing limited data, or seeking alternative products and services that may not serve them as well. In each case, the loss of trust results in an inferior experience for a user. For example, where a user has children and could benefit from focus advertising related to diapers, such focused advertising may not occur where the user either neglects to provide relevant information, intentionally refuses to provide such information, or provides misinformation such as stating that they have only grown children.

Where a user's data is protected by a privacy component 340, increased trust can result. Where increased trust occurs, users can be expected to provide more and better information. This information can then facilitate improved accuracy in relevancy of advertising content. Improved relevance can benefit the user in more focused advertising, reduced irrelevant advertising, increased value in the advertising (e.g., increased savings, less volume of advertising, . . . ), or combinations thereof among many other benefits as will be appreciated by one of skill in the art. The general conversation related to the benefits of user privacy through a privacy component is not presented to limit the scope of the disclosed subject matter. One of skill in the art will appreciate that a myriad of techniques and systems can be employed to effectuate a privacy component 340 and that the particular manner of effecting the privacy component 340 is not the focus of the disclosed subject matter as contrasted with the benefits of employing an effective privacy component 340. Thus, one of skill in the art will appreciate that any and all means for protecting the privacy of user data and any and all privacy components 340 are within the scope of the disclosed subject matter.

Advertising content server component 310 can be communicatively coupled to a user device component 360 comprising an interface component 370. Interface component 370 can be the same as or similar to interface component 270 or interface component 170 of systems 200 and 100 respectively. The communicative coupling between advertising server component 310 and user device component 360 can be over a communications framework 380. Communications framework 380 can be a wired or wireless communications framework (e.g., LAN, cellular network, WAN, Wi-Fi network, radio broadcast, satellite link, combinations thereof, . . . )

System 300 in general illustrates aspects of a user selectable advertising network distributed between a content provider and a basic user device. For example, user device component 360 can be a smart phone with an interface component 370 such as a mobile web browser. Continuing the example, advertising content can be formed into channels by advertising content subset component 330 and user preferences can be sent can be sent through the mobile web browser across the cellular network and internet (e.g., communications framework 380 comprises both the cellular network and the internet) to selection component 350 residing on the advertising content server component 310. The user's preferences can then selectively allow advertising content, dynamically adapted to a specific end-user by dynamic modification component 355, to be returned to the smart phone across the internet and cellular networks while protecting the user's personal data behind privacy component 340. This can result in users accessing relevant advertising content streams related to user preferences that have been tailored for the targeted end-user, for example, expressly opting into a particular advertising channel related to an interest of the user wherein the advertising channel represents advertising related to said interest, the ads comprising the selected stream being further adapted to the user by modification of the ads secondary aspects.

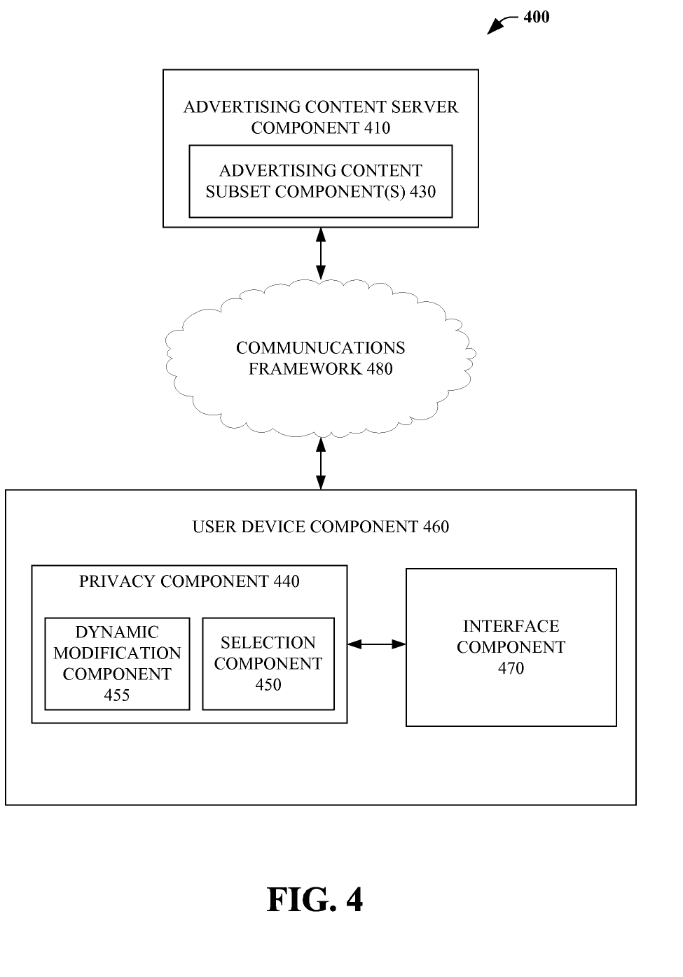

FIG. 4 similarly illustrates a system 400 that facilitates providing access to selected advertising networks. System 400 can be similar to system 300. System 400 can include advertising content server component 410 that can be similar to advertising content server component 310 of system 300. Advertising content server component 410 can include an advertising content subset component(s) 430 that can be the same as or similar to advertising content subset component(s) 330 of system 300 and/or advertising content subset components 0 to N (210A, 210B . . . 210C) from system 200.

System 400 can further include user device component 460 that can be the same as or similar to user device component 360 from system 300. User device component 460 can include interface component 470 which can be the same as or similar to interface component 370. Advertising content server component 410 and user device component 460 can be communicatively coupled by communications framework 480 which can be the same as or similar to communications framework 380 of system 300.

System 400 can further include privacy component 440, selection component 450, and dynamic modification component 455, which can be similar to privacy component 340, selection component 350, and dynamic modification component 355, of system 300, respectively. In contrast to system 300, system 400 locates the privacy component 440, selection component 450, and dynamic modification component 455, on the user device component 460 side of the communications framework 480. This can facilitate, for example, keeping local records of preference data and communicating this information over the communications network to the advertising content server component 410. This illustrates that in an aspect the selection component (350, 450) and dynamic modification component (355, 455) can reside on either the server side (e.g., as in system 300) or client side (e.g., as in system 400). The selection component 450 can further be located outside either the server or client (e.g., such as on a 3^{rd} party server, in a NodeB, on a gateway . . . ) but such configuration is not specifically illustrated, but will be appreciated by one of skill in the art.

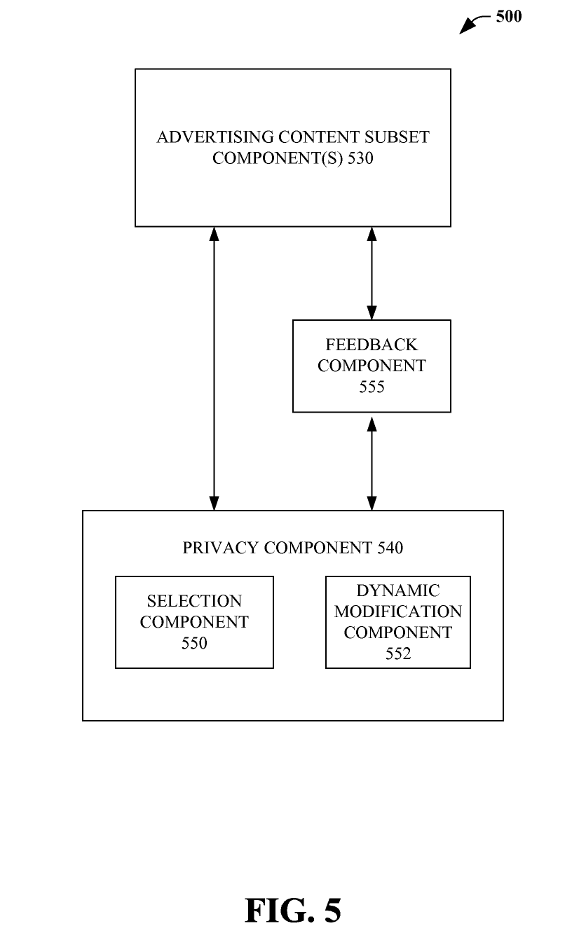

FIG. 5 illustrates a system 500 that facilitates providing access to selected advertising networks. System 500 can include advertising content subset component(s) 530. Advertising content subset component(s) 530 can be the same as or similar to advertising content subset component(s) 430 of system 400, advertising content subset component(s) 330 of system 300, and/or advertising content subset component(s) 230 of system 200. As such, advertising content subset component(s) 530 can source one or more advertising streams. These advertising streams display a cohesive aspect in that each stream is related to selection indicia facilitating selection of advertising content related to the stream by selection component 550. The advertisements comprising the advertising streams can further be dynamically modified by dynamic modification component 552.

Selection component 550 can be the same as or similar to selections component 450, 350, 250, and/or 150 in systems 400, 300, 200 and 100 respectively. Dynamic modification component 552 can be the same as or similar to dynamic modification component 455, 355, 260, and/or 160 in systems 400, 300, 200 and 100 respectively. Advertising content subset component(s) 530 can be communicatively coupled to selection component 550 and dynamic modification component 552. Selection component 550 can selectively facilitate access to advertising content subsets or components of one or more advertising content subsets based on user preferences such as, for example, subscribing to a particular advertising content channel. Selected access can refer to selecting from among the different subsets, within any one subset, or combinations thereof. Each of these selected advertising channels can comprise a plurality of advertisements that can be modified dynamically to adapt the ads individually to a target end-user by modification of secondary advertisement aspects. This dynamic modification, including intelligent adaptation, can be the same as, or similar to, that describing the dynamic modification components disclosed herein, supra (e.g., dynamic modification component 455, 355, 260, and/or 160).

Similar to other selection components disclosed herein (e.g., 150, 250, 350, 450 . . . ) selection component 550 can further adapt selection dynamically. Thus, as selection criteria change the selection component can intelligently adapt to select appropriate advertising content. For example, where a user prefers books to movies, but now has little time to read for pleasure, the selection component 550 can react by dynamically allowing increased access to streams of advertising content related to movies. One of skill in the art will appreciate that a limitless number of variations can be achieved and that all such examples are within the scope of the disclosed subject matter.

System 500 can include privacy component 540 that can be the same as or similar to privacy component 340 and/or 440 of system 300 and 400 respectively. Privacy component 540 can facilitate protection of user data related to selection component 550 and/or dynamic modification component 552.

System 500 can further include feedback component 555. Feedback component 555 can facilitate providing feedback between a user and an advertising content provider. Feedback can be, for example, providing a coupon to a user for being a loyal subscriber to a particular advertising channel. As another example, feedback can be an indication of desired features in future products. As yet another example, feedback can indicate alternative criteria for advertising content channel selection. A still further example of feedback can be indicia related to subset criteria for advertising content comprising an advertising stream. This can allow advertising content providers to interact in a meaningful manner with users to tune specific advertising content streams, add/remove/alter the number and types of advertising content channels available, provide additional motivational features to interactions with users, glean information related to future product development, and a host of other benefits from maintaining an additional line of communication with users in a user community. The examples given here are provided for illustration only and are not provided to limit the scope of the disclosed subject matter. One of skill in the art will appreciate that a nearly limitless number of forms of feedback can be employed and that all such permutations are within the scope of the disclosed subject matter.

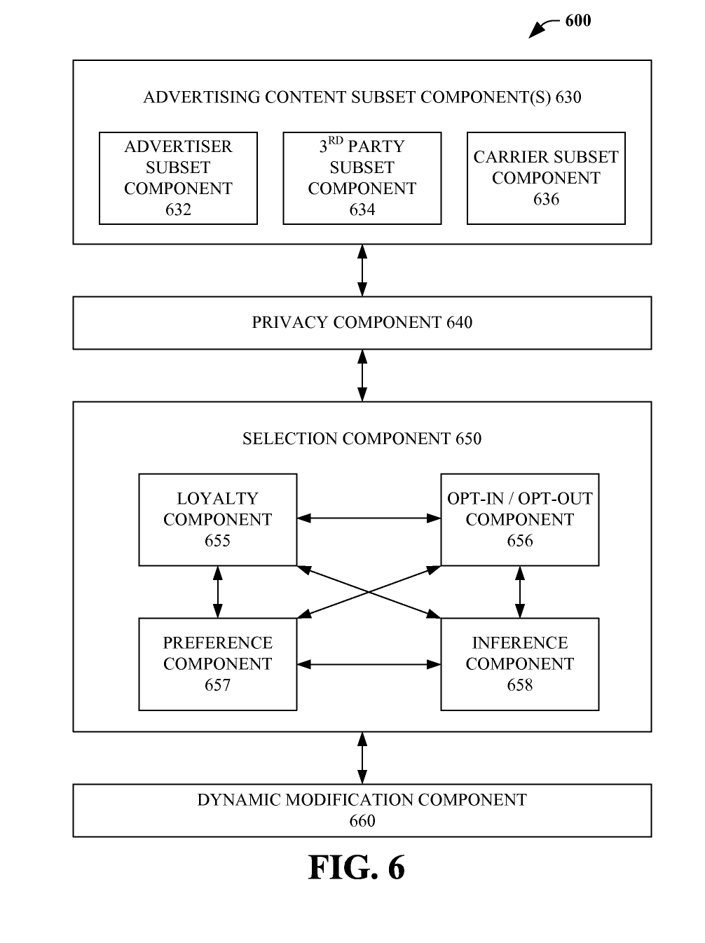

FIG. 6 illustrates a system 600 that employs intelligence to facilitate providing access to selected advertising networks. System 600 can include advertising content subset component(s) 630 that can be the same as or similar to those described in previous figures. Advertising content subset component(s) 630 can include subset components such as advertiser subset component 632, 3^{rd} party subset component 634, carrier subset component 636, combinations thereof, or other subset components (not illustrated). For example, advertiser subset component 632 can be related to advertising content related to a particular product or service advertiser, for example, advertisements for a particular brand of hiking equipment. Similarly, 3^{rd} party subset component 634 can source advertising content related to the 3^{rd} party, for example, where the 3^{rd} party is a lobbyist group, the advertising can relate to the lobby, for instance, the beef lobby can source positive beef advertising content and negative chicken, pork, and lamb advertising. Carrier subset component 636 can source content related to a particular carrier, for example, where a web portal has advertising agreements with select corporations, the advertising content for that portal's advertising channel can be comprised of advertising content from those corporations, for instance facilitating branding of web portals by defining a brand through the selection of advertising related to the web portal.

System 600 can further comprise a privacy component 640. Privacy component 600 can be the same as or similar to privacy component 340, 440, and/or 540 of systems 300, 400 and 500 respectively. Privacy component 640 can facilitate maintaining the privacy of a user by restricting or otherwise protecting user data. For example, user data can be made anonymous. User data can also be, for example, protected by being relegated to trusted partner processing or processing through a trusted 3^{rd} party, for instance a trusted 3^{rd} party server handles selection of streams such that user data is not made directly available to an advertiser. Further, user data can be restricted so that data that a user does not want shared is restrained from being transmitted at all. Numerous other privacy methods, many far more refined than the basic examples provided here are considered within the scope of the disclosed subject matter as will be appreciated by one of ordinary skill in the art.

The system 600 further includes selection component 650 and dynamic modification component 660. Selection component 650 can be the same as or similar to those described in other FIGS. 150, 250, 350, 450 and/or 550) and dynamic modification component 660 can be the same as, or similar to, dynamic modification components disclosed herein (552, 455, 355, 260, and/or 160). Selection component 650 can include loyalty component 655 that can be similar to feedback component 555 of system 500. Loyalty component 655 can provide feedback between advertising content providers and users related to loyalty to advertising content subsets (e.g., channels or streams). This can facilitate an improved user experience as herein disclosed. Selection component 650 can further include opt-in/opt-out component 656 that can facilitate a user opting into or out of an advertising channel or stream. This opting in or out can be explicit or implicit as herein disclosed. Further, selection component 650 can include preference component 657. Preference component 657 can facilitate accessing user data related to user preferences. Indicia related to user preferences can facilitate selection of relevant advertising content streams or portions thereof by selection component 650.

The system 600 further includes an inference component 658. Inference component 658 can be an intelligent component. Further, inference component 658 can be included in selection component 650, dynamic modification component 660 (not illustrated), or be located elsewhere (not illustrated). The inference component 658 can be utilized to facilitate constructing, altering, and/or prioritizing user preference indicia, etc., based at least in part upon user activity and/or behavior. For example, the inference component 658 can infer user behavior, user activity, data selection in relation to a user log, configuration settings for a particular user in accordance to user log data, etc. For instance, user selection of advertising streams related to travel destinations can result in an inference that airline and hotel advertising channels can be of interest to the user. In another instance, user preferences for vocal music, vehicle, neighborhood, and clothier, can be employed to infer the preference for the gender of voiceovers, background music, audio volume, brightness, vocal tempo, and other secondary aspects used in tailoring advertising to the targeted end-user.

It is to be understood that the inference component 658 can provide for reasoning about, or infer states of, the system, environment, and/or user from a set of observations as captured by way of events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The selection component 650 and dynamic modification component 660 can further utilize an interface component similar to those described in other FIGS. 170, 270, 370, 470, not illustrated in FIG. 6) that provides various types of user interfaces (e.g., presentation component and/or view components) to facilitate interaction between a user and any component coupled to selection component 650 or dynamic modification component 660. It will be appreciated that the presentation component and/or similar view components can be incorporated into the system 600 as integrated with or separate from selection component 650 or, for example, as part of dynamic modification component 660 (not illustrated). The presentation component can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components incorporated into the selection component 650, for instance opt-in/opt-out component 656.

The user can also interact with the interface regions to select and provide information by way of various devices such as a mouse, a roller ball, a keypad, a keyboard, a pen and/or voice activation, for example. Typically, a mechanism such as a push button or the enter key on the keyboard can be employed subsequent to entering the information in order to initiate an action. However, it is to be appreciated that the claimed subject matter is not so limited. For example, merely highlighting a check box can initiate information conveyance. In another example, a command line interface can be employed. For example, the command line interface can prompt (e.g., by way of a text message on a display and an audio tone) the user for information by way of providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

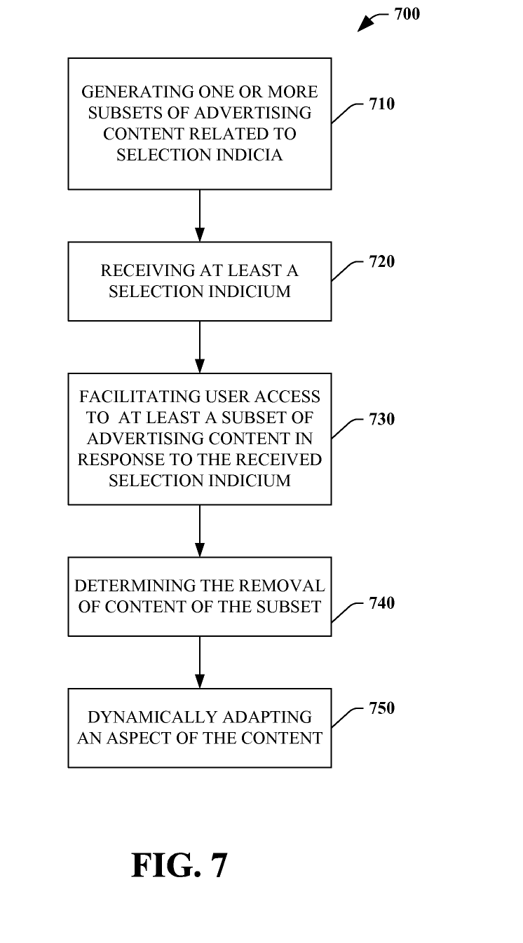

FIGS. 7-10 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states by way of a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates an exemplary methodology 700 that facilitates providing access to selected advertising networks. At 710, one or more subsets of advertising content can be generated. These subsets can be cohesively themed as described herein. These subsets (e.g., streams, channels . . . ) can be related to selection indicia to facilitate access by a user through the execution of methodology 700.

As discussed herein with regard to related systems, advertising content can be general or specific advertising content (e.g., unrelated advertising content or themed advertising content). This advertising content can then be adapted to themed advertising content subsets. For example, where advertising content is related to many different modes of travel, a subset of advertising content for each mode of travel can be generated. Also for example where advertising content is unrelated, cohesive streams can be formed based on indicia of selection criteria that will be later employed in selecting from the generated advertising content channels. One of skill in the art will appreciate that subsets of advertising content can be cohesive around any theme from the most simple to the most complex and that all such cohesive subsets (e.g., channels, streams . . . ) are within the scope of the disclosed subject matter regardless of the level of complexity.

Further, as disclosed herein, the number and type of subsets of advertising content created can be adapted dynamically. Dynamic adaptation of the advertising content subsets can be based on, for example, the available advertising content from which subsets are formed, changes in the indicia related to selection of advertising content subsets, combinations thereof, or other factors that can impact the relevancy of formed advertising content streams. It is foreseen that optimized numbers and types of subsets can be achieved that balance the goals and resources of advertisers with the constraints of ever advancing technology with the benefits and burdens of users. For example, optimization can result in fewer subsets with broader focus than is technologically feasible where transmission efficiency can limit throughput of advertising content to users and users are able to effectively select relevant advertising from the available subsets. In another example, the optimization can result in a massive plurality of subsets such that selection indicia can effectively be hashed against subsets to find exact matches (e.g., a subset for each user, wherein formation of subsets collapses with selection by a user.)

At 720, at least a selection indicium can be received in methodology 700. Receiving one or more selection indicia can facilitate access to selected subsets of advertising content. The selection indicia can be related to or associated with user preferences as disclosed herein at length. The selection indicia can be employed in determinations for allowing access to advertising content across a plurality of advertising content subsets, within a subset, or combinations thereof. For example, an indicium can be related to a user's preference for fast cars. This indicium can facilitate selecting one or more ad channels relating to fast cars. Further, in this example a second indicium can indicate that the user has young children such that the indicium can facilitate selection of content with the selected streams that relate to children. Alternatively, the indicia of children can be employed to select advertising content subsets that are popular among other users with children. One of skill in the art will appreciate that as the number and quality of indicia increases, the ability to select relevant advertising content rapidly increases and can typically be seen as being technologically limited, however, this disclosure also anticipates that as these technological hurdles are overcome (e.g., massive memories, voluminous connectivity ultra fast processing . . . ) the value of highly selectable advertising content systems and methodologies will burgeon and provide increasing value to users. Thus, one of ordinary skill in the art will appreciate that all permutations of selection indicium are with the scope of the disclosed subject matter.

At 730 at least a subset of advertising content can be made accessible in response to receiving the at least one selection indicium. Thus, a user can indicate a preference, this preference can be related to a selection indicium which can be received in methodology 700 at 720 and can be employed at 730 in making the one or more subsets of advertising content generated at 710 accessible to the user.

At 740, the subset can be analyzed and a determination can be made to remove access to select content of the stream based on user preferences. For example, an advertisement can be included in a stream where the advertisement is highly rated with a user's peer group and meets the user's goals of buying a particular product that is environmentally friendly. However, the user can specifically have indicated that products from a particular retail location of a vendor are not acceptable because the retail location is in a rough neighborhood. As such, the ad can make it into the stream but be rejected at 740 for the very narrow factor. In contrast the same ad can be accessed where the product is at a different retail location for the same vendor.

At 750, the advertisements comprising the stream can be dynamically adapted to a target end-user. This adaptation can be by modification of the secondary aspects of the advertising content within an individual advertisement of the stream. In a very generalized manner, the cohesiveness of a stream can act as a filter for the primary aspects of advertising such that the personalization of relevant advertising can be focused on the secondary aspects of an advertisement in an efficient and dynamic manner. While this general description is meant only to provide context and not limitation, it is effective to visualize that streaming advertising into meaningful and valuable advertising to a user can be distinct from the particular technique employed to sell any selected product or service. Thus, at 750 advertising in the stream is presumed to be sufficiently relevant to a user such that only the secondary aspects of the advertisements in the stream need be tailored within any one or more of the individual ads comprising the stream to adapt the ad more effectively to the individual end-user. At this point methodology 700 can end.

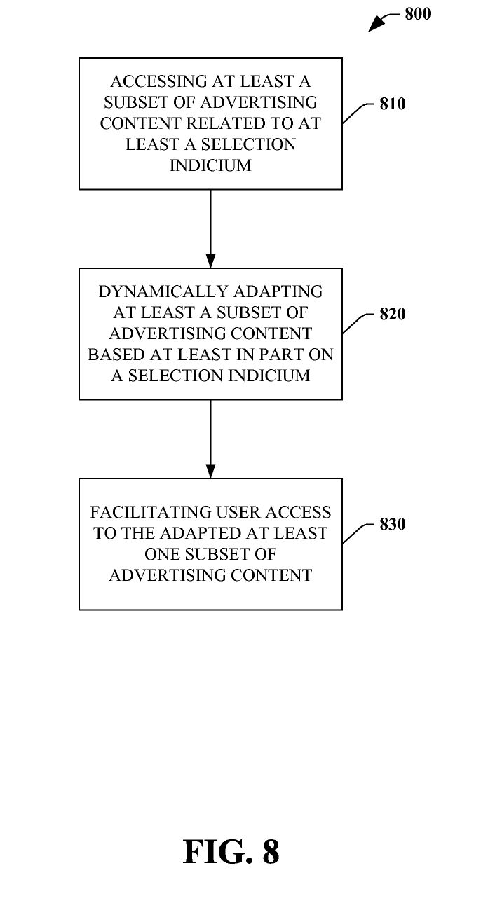

FIG. 8 illustrates an exemplary methodology 800 that facilitates providing access to selected advertising networks. At 810 at least a subset of advertising content related to at least a selection indicium can be accessed. As disclosed herein, advertising content can be formed into cohesive subsets such the advertising channels or streams result. These channels or streams of advertising content can be further related to selection indicia as metrics to facilitate selection of the advertising content streams or channels. For example, an ISP can provide a plurality, for instance, ten advertising content channels, each differently related to various selection indicia. These ten advertising channels can be accessed to facilitate selection of select streams or portions thereof. Similarly, for example, where a car brand generates, say five streams of advertising content, these five streams can also be accessed in addition to and/or in place of accessing the ISP advertising channels. One of skill in the art will appreciate that vast numbers of advertising content subsets can exist and that some or all of these can be accessed in whole or in part within the scope of the instant disclosure.

At 820, based at least in part on a selection indicium, at least a subset of the advertising content can be dynamically adapted. Where a user preference, as disclosed at length herein, is related to a selection indium, the indicium can be employed in selecting from among and adapting the advertising subsets accessed at 810. Adapting a selected stream can include adapting the secondary advertising aspects of one or more subsets in whole, in part, or combinations thereof. Continuing the above example, an indicia that the user owns a minivan can facilitate selecting an advertising channel of the ISP related to automobiles (e.g., content related to tune ups, repairs, accessories, tires, fuel, car washes, books on repair, touring by car, music about cars, car exhibitions . . . ). Similarly, the same indicium can facilitate selecting an advertising stream from the car brand streams relating to minivan products and services from that particular car brand (e.g., car brand lube specials, car brand vehicle upgrade programs, car brand loyalty programs.) The secondary advertising aspects can be adapted to, for example, tailor ads to present only the stores closest to the user at a particular time (e.g., the store is the primary aspect, the location is a secondary aspect), ads for products for the specific minivan the user owns from an advertisement for an auto parts supplier (e.g., the auto parts supplier is the primary aspect, the available parts are a secondary aspect), or any other of a nearly limitless number of aspects that can be tailored based on user information as will be appreciated by one of skill in the art.

At 830, accessing the selected advertising channels or portions thereof from 820 can be facilitated for a user. Methodology 800 can thus facilitate a user accessing relevant advertising content based on indicia that can be related to the user. At this point methodology 800 can end.

The indicia in both methodology 700 and 800 can be generally related to user preferences. Further, the indicia can be related to other aspects related to the user, for example the indicia can indicate the capabilities of the user device being employed to access the advertising content, for instance that audio content is preferable to video content on a portable music player. Other indicia are also anticipated, for example, regional marketing indicia, communications network indicia, and corporate indicia to name but a few. One of skill in the art will appreciate that indicia related to subsetting and selection of subsets can be related to almost any relationship, experience, condition, or behavior of a user, a market, a system or environment, an advertising campaign, etc., and that all such indicia are considered within the scope of the present disclosure. Generally speaking, within this disclosure indicia are related to user preferences but the innovation is not so limited.

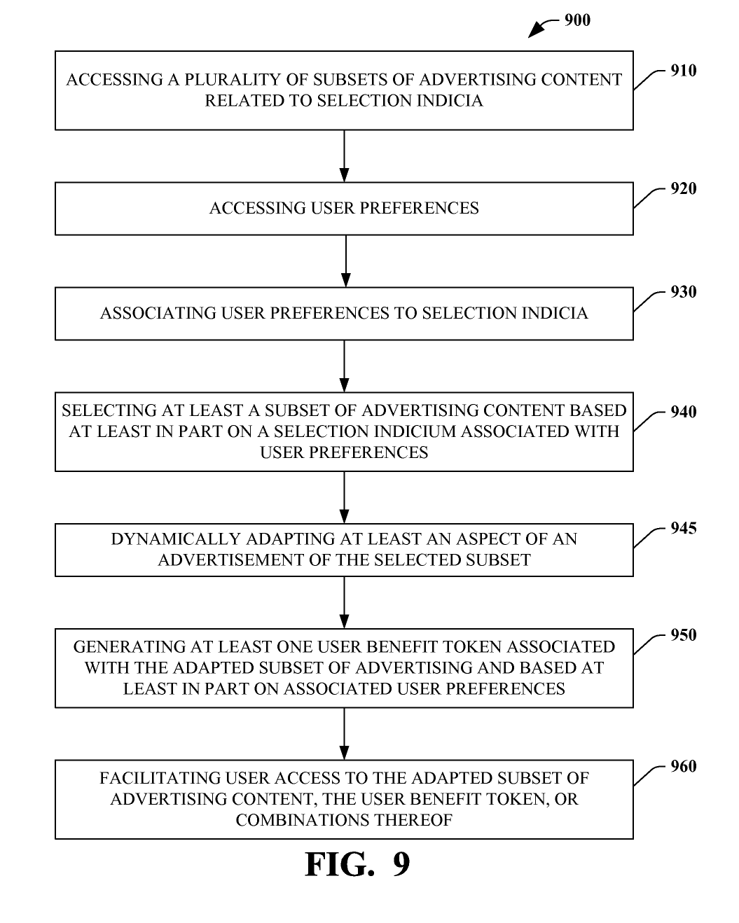

FIG. 9 illustrates an exemplary methodology 900 that facilitates providing access to selected advertising networks. At 910, subsets of advertising content can be accessed as disclosed herein. These subsets can be related to selection criteria also as disclosed herein. At 920, user preferences can be accessed. At 930, user preferences can be associated with selection indicia. At 940, at least a subset of the advertising content accessed can be selected based at least in part on the selection indicia associated with a user's preferences.

At 945, the advertisements comprising the selected ad streams can be dynamically adapted to a particular end-user. This can be adapting the secondary advertising aspects of a particular advertisement. Secondary advertising aspects are those aspects not related to the primary aspects of the advertisement, namely the product or service. The secondary aspects relate to how an ad sells the primary product or service rather than the primary product or service itself. This can include a nearly limitless number of modifications that can include, for example, sounds, smells, brightness, tempo, languages, images, colors of products, selections of products for a primary retailer or wholesaler, the ethnic appearance of a salesperson, the gender of salespersons or voiceovers, etc. One of skill in the art will appreciate that effective adaptation of these secondary advertising aspects or factors can significantly affect the efficacy of an ad for a particular product. Thus, modification of these secondary factors in an efficient manor can be of great benefit. Advertising channels are presumed to present relevant primary content, and perhaps at some level some relevant secondary aspects, thus dynamic adaptation, as at 945, can efficiently present very effective ads that are highly tailored to a specific targeted end-user.

At 950, a user benefit token can be generated. This user benefit token can be associated with the selected and adapted subset of advertising content and also based at least in part on the associated user's preferences. This benefit token can be, for example, a coupon, a discount, a special pricing option, a layaway benefit, a perk, special shopping experience, or nearly a limitless number of other benefits that can be generated for the user based on the user's preferences and the subset of advertising content selected based on the selection indicia. For example, where a user enjoys hiking, selection indicia can facilitate selection of an outdoor store advertising stream with content cohesively related to outdoor activities. The preference for hiking and the selection of the outdoor store advertising channel can result in a discount offer being generated for the user, for example, for exotic hiking vacations on the Yucatan peninsula that are offered by a travel agency associated with the outdoor store. Moreover, where the end user speaks Spanish and English, the advertisement can be adapted to be presented with some voice over in Spanish to make it more exotic and appealing.

One of skill in the art will appreciate that benefit tokens can be of immense value to user selectable advertising networks. Where user selectable advertising networks facilitate highly relevant advertising, the costs of advertising can decrease for advertisers, for example, by reducing the amount of advertising that must be done to reach a predetermined portion of a market. Further, where advertising is relevant a user is arguably more likely to respond positively to the relevant advertising and improved cost to effectiveness ratios for advertising can be achieved. While the benefits to the advertiser of relevant advertising through user selectable advertising networks can obviously result in higher premiums to produce advertising (e.g., more permutations for advertising for the same product or service to accommodate user preferences) and present advertising to users (marketing agencies can foreseeable charge higher fees to present advertising with increased margin exists), some additional margin is foreseen to be employed to present benefit tokens to users. At a very basic level, where costs for advertisers to successfully market to a user decrease, it is anticipated that a portion of this savings will be employed in benefiting the user. These additional user benefit tokens can foreseeably generate good will towards identifiable advertising channels or streams that can result in increased user participation in these preferable advertising networks.

At 960, access to the selected and adapted advertising content subset, benefit token or combination thereof can be facilitated. This can result in the user being given access to the benefit token together or separately from the advertising content subset. For example, a coupon can be mailed to a user, a discount can be presented within the advertising stream, access to a premium advertising network can be offered, etc. At this point methodology 900 can end

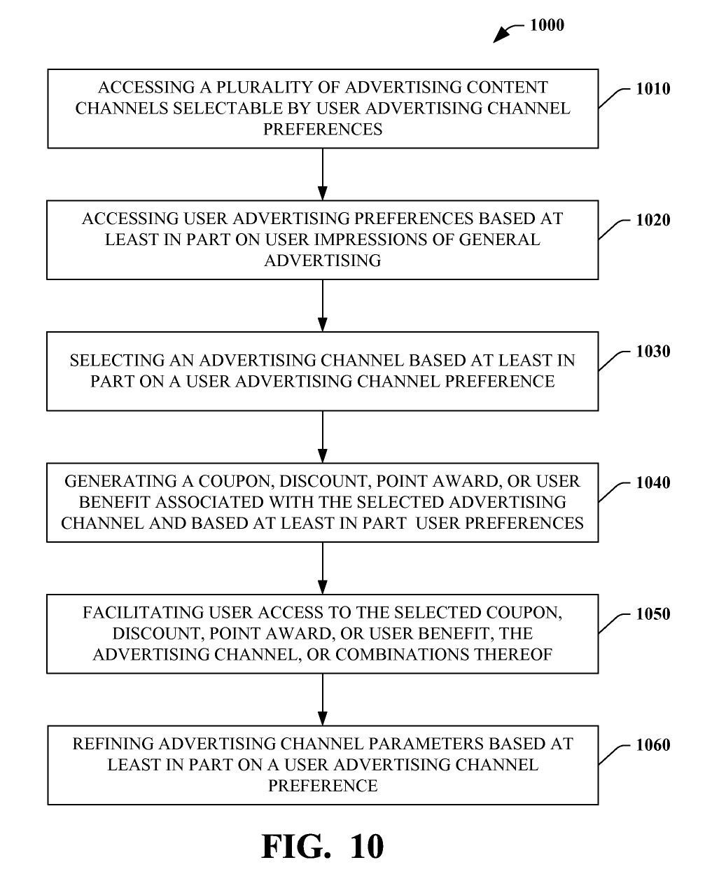

FIG. 10 illustrates an exemplary methodology 1000 that facilitates providing access to selected advertising networks. At 1010, subsets of advertising content can be accessed as disclosed herein. These subsets can be related to user preferences as disclosed herein. At 1020, user preferences for advertising preferences can be accessed based at least in part on user impressions of general advertising. Thus, a user's historic impressions towards advertising can be employed to facilitate selection of advertising to be made available to a user. For example, where a user has historically indicated positively to advertising for skiing in high end resorts but has negatively indicated to advertising for medium end ski areas, this information can be tracked and accessed. Thus, at 1030, this information can be employed in selecting an advertising channel. Continuing the example, the advertising streams selected can relate to high-end vacations such that ski vacation ads in the channel would be ski vacations at high end resorts and be more relevant to the user. One of skill in the art will appreciate that data mining and profile development can provide benefits to systems and methods for providing relevant content to users and will further appreciate that all such techniques and systems as related to the disclosed innovation are within the scope thereof.

At 1040, a coupon, discount, point award, or user benefit associated with the selected advertising content subset and based at least in part on a user's preferences can be generated. This can be similar to or the same as methodology 900 at 950. In very general terms, a user can be presented with a benefit token, and more specifically, a coupon, discount, point award, or user benefit resulting from the relationship of the user with an advertising content stream and that user's preferences.

At 1060, feedback can be generated, as disclosed herein, allowing refinement of the advertising channel parameters based at least in part on a user advertising channel preference. This feedback can be, for example indications of what other channels a user is selectively accessing, user purchasing patterns as relate to selected advertising channels, brand preferences, user group trends, combinations thereof, or nearly any other user advertising channel preference available. This feedback s disclosed herein can be employed by advertisers and advertising content providers to refine advertising content and grouping of that content to provide greater relevance to selected users. In an example, where a user regularly responds to advertising content for ecologically friendly products, the subscribed channel can increase advertising for eco-friendly products, reduce non-eco-friendly products, suggest related streams with eco-friendly products, etc. In another example, a user preference for advertising related to high gas mileage cars can be employed by a car manufacturer to generate advertising for future car models with high gas mileage to mine consumer reactions and help direct the product development cycle. At this point methodology 1000 can end.

In an aspect the methodologies and systems disclosed herein can facilitate an advertising network reputation method of selection. Where users in a user pool have positive reactions to an advertising network, that networks reputation can serve as a basis for other users to subscribe to that advertising content stream or otherwise making that stream available to users (e.g., an ISP may decide to carry an advertising channel where it is highly regarded in other markets). One of skill in the art will appreciate that aspects of social networking and inferential determinations can be readily coupled with advertising network reputation development and that these aspects are within the scope of the disclosed subject matter as they relate to user selectable advertising networks.

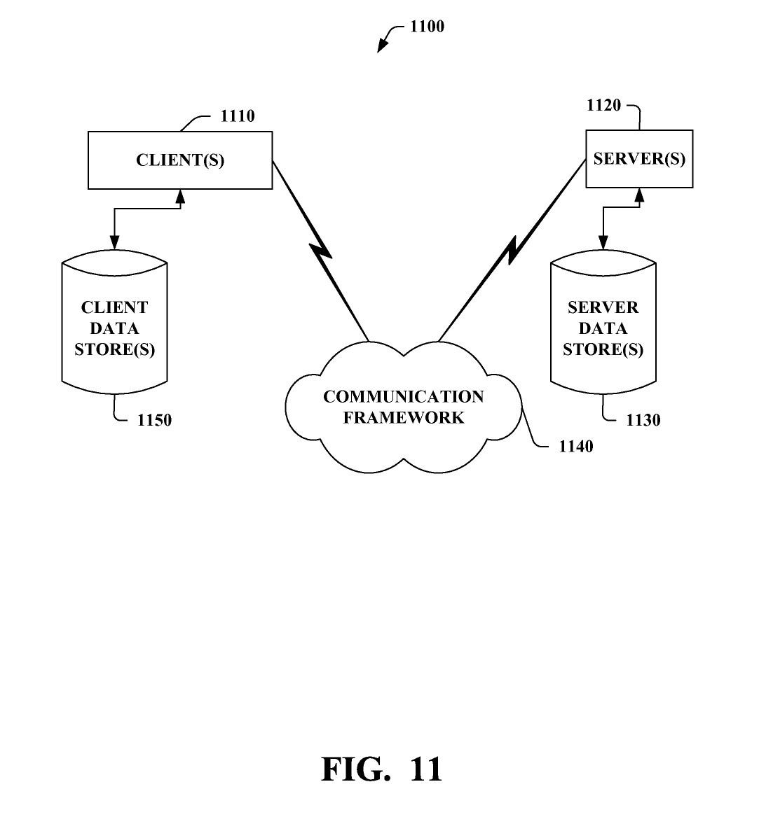

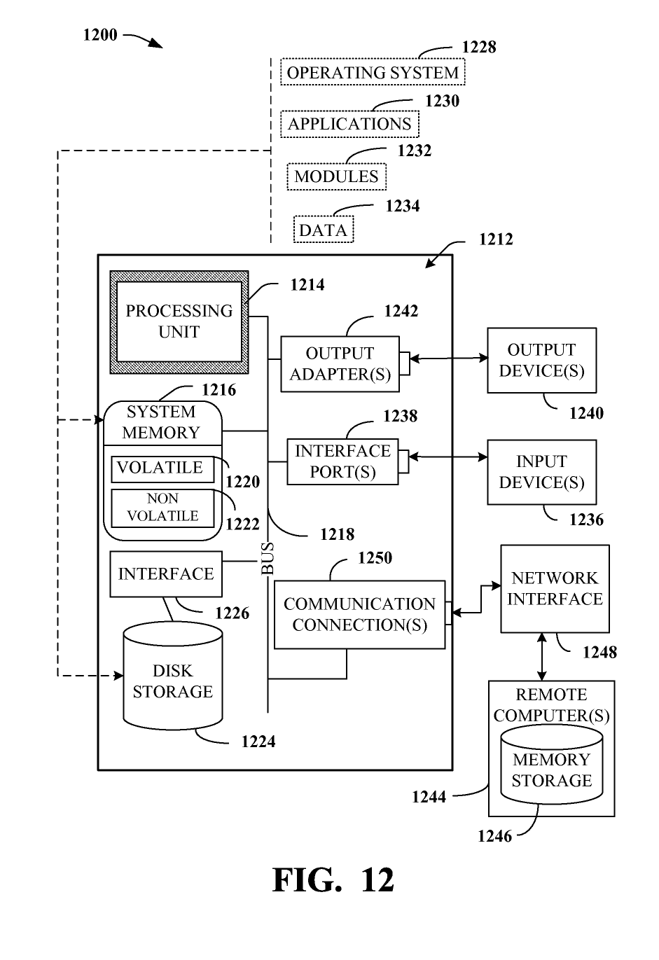

In order to provide additional context for implementing various aspects of the claimed subject matter, FIGS. 11-12 and the following discussion is intended to provide a brief, general description of a suitable computing environment in which the various aspects of the subject innovation may be implemented. For example, a selection component, as described in the previous figures, can be implemented in such suitable computing environment. Where the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 11 is a schematic block diagram of a sample-computing environment 1100 with which the claimed subject matter can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject innovation, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1120.

With reference to FIG. 12, an exemplary environment 1200 for implementing various aspects of the claimed subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory. Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the claimed subject matter can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems, FIOS modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer-implemented content generating system having a user interface that facilitates access to and dynamic customization of a selection of advertising networks, comprising:
a processor communicatively coupled to a memory having stored thereon computer-executable instructions configured to implement the content generating system including:
at least one advertising content component facilitating access to advertising content;
a subset component that facilitates forming subsets of advertising content such that the advertising content comprising the subsets are cohesively related;
a selection component that facilitates selection of relevant subsets of advertising content;
a dynamic modification component that modifies at least an aspect of the selected advertising content subset to a target end-user; and
at least one interface component to facilitate access to the dynamically modified selected subsets of advertising content.

2. The system of claim 1, wherein the selection of the dynamic modification, the selection of relevant subsets of advertising content, or combinations thereof, is based at least in part on user preferences.

3. The system of claim 2, wherein the user preferences include an opt-in, an opt-out, an explicit or implicit preference, selecting an item including a subset of advertising content element, a user behavior, a user action, an implicit preference, a user schema, a user history, a user preference, a buying pattern, a brand preference, a demographic datum, or combinations thereof.

4. The system of claim 1, wherein the at least an advertising component further comprises at least one memory store wherein at least some advertising content is stored.

5. The system of claim 1, further comprising at least one privacy component.

6. The system of claim 5, wherein the selection component is communicatively coupled to the subset component by way of a communications framework such that data is subject to privacy constraints related to the privacy component.

7. The system of claim 6, wherein the privacy constraints restrict information exchange by defining a permission level allowing personal information to be employed at least one of when it is stored on a host device for selection of relevant subsets of advertising, when it is shared with entities so authorized for said sharing in relation to selection of relevant subsets of advertising, or when the personal information is first transformed to make it anonymous before employing the personal information in a manner related to selection of relevant subsets of advertising.

8. The system of claim 1, wherein the selection of relevant subsets of advertising content is based at least in part on a rating, reputation, or combination thereof, of an advertising content subset.

9. The system of claim 8, wherein the rating, reputation, or combination thereof, is at least in part generated in relation to at least one entity, wherein the at least one entity includes a single user, a group of associated users, a subset of a group of associated users, or combinations thereof, and wherein the rating, reputation or combination thereof, is employed in selection of advertising content for consumption by the at least one of the generating entity or a second entity.

10. The system of claim 1, further comprising a feedback component to facilitate access to data related to interactions between the selection component, the dynamic modification component, the subset component, or combinations thereof.

11. The system of claim 10, wherein the feedback component generates benefit tokens.

12. The system of claim 11, wherein the benefit tokens include coupons, discounts, special pricing, premium services, point awards, layaway service, special shopping conditions, gifts, rewards, recognition, or combinations thereof.

13. The system of claim 9, wherein the feedback component generates data related to refinement of advertising content, dynamic modification, advertising content subset criteria, or combinations thereof.

14. The system of claim 1, further comprising an inference component to facilitate forming inferences related to dynamic modification of at least one aspect, selection criteria, user preferences, privacy constraints, advertising content subset formation, or combinations thereof.

15. A computer-implemented method that facilitates access to a selection of dynamically adapted content from selected advertising networks, comprising:
generating one or more subsets of advertising content related to selection indicia;
receiving at least a selection indicium related to user selection of at least one advertising content subset or portion thereof;
facilitating a user's access to at least a subset of advertising content in response to the received at least one selection indicium;
determining the removal of portions of an accessed subset of advertising content in response to at least one user preference; and
dynamically adapting at least an aspect of an accessed advertising content according to a user preference.

16. The method of claim 15, further comprising:
accessing at least a subset of advertising content related to at least a selection indicium;
selecting at least a subset of advertising content based at least in part on a selection indicium related to a user selection of at least one advertising content subset or portion thereof;
facilitating user access to the selected at least one subset of advertising content.

17. The method of claim 15, wherein the received selection indicium is related to a user preference including an opt-in, an opt-out, an explicit or implicit preference, selecting an item including a subset of advertising content element, a user behavior, a user preference, a user action, an implicit preference, a user schema, a user history, a buying pattern, a brand preference, a demographic datum, or combinations thereof.

18. The method of claim 17, further comprising generating at least one user benefit token associated with a selected advertising content subset and an associated user preference.

19. The method of claim 15, further comprising a feedback component associated with generating data related to refinement of advertising content, exclusion of advertising content, dynamic adaptation of advertising content, advertising content subset criteria, or combinations thereof.

20. A computer-implemented method that facilitates access to a selection of advertising networks, comprising:
generating one or more subsets of advertising content, at a server, the subsets related to selection indicia associated with user preferences including at least a user selectable user preference;
accessing at least a subset of advertising content at a client system;
selecting at least a subset of advertising content at the client system;
receiving at the server at least the selection indicium related to user selection of the at least one advertising content subset;
facilitating a user's access to at least a subset of advertising content in response to the received at least one selection indicium;
dynamically altering a secondary characteristic of any accessed advertising content; and
generating at least one user benefit token associated with a selected advertising content subset and an associated user preference.
